(19) United States
(12) Patent Application Publication
(10) Pub. No.: US 2024/0005262 A1
(43) Pub. Date: Jan. 4, 2024

(54) SYSTEM AND METHOD FOR DEDUCTION OF VEHICLE RENTAL FROM DELIVERY INCOME

(71) Applicant: Joel Hale, Indianapolis, IN (US)

(72) Inventor: Joel Hale, Indianapolis, IN (US)

(21) Appl. No.: 18/338,034

(22) Filed: Jun. 20, 2023

Related U.S. Application Data
(60) Provisional application No. 63/356,566, filed on Jun. 29, 2022.

(51) Int. Cl. G06Q 10/0834; G06Q 30/0645

(52) U.S. Cl. CPC G06Q 10/08345; G06Q 30/0645; G06Q 50/30

(57) ABSTRACT

A system and method of deducting a vehicle cost from a delivery income may include at a vehicle pickup location, verifying an arrival of a driver. A vehicle may then be assigned to the driver. The vehicle may be chosen by the driver before arrival at the pickup location. Then, the driver may complete a delivery route using the rental vehicle. The delivery route may be assigned to the driver at the pickup location. After the driver completes the deliveries, the driver may return to the vehicle pickup location where the driver is re-verified. After the driver returns the vehicle, a payment may be calculated for the driver based on the delivery route. Then, the vehicle rental amount may be deducted from the payment and the resulting amount may be transferred to the driver.

### CROSS-REFERENCE TO RELATED APPLICATIONS

This application claims the benefit of U.S. Provisional Application No. 63/356,566 filed on Jun. 29, 2022. The entire disclosure of the above application is incorporated herein by reference.

### FIELD

The present technology relates to a delivery system and method, including where an amount of a vehicle rental is deducted from the delivery income of a delivery driver.

### INTRODUCTION

This section provides background information related to the present disclosure which is not necessarily prior art.

Last mile delivery refers to the movement of a good from a transportation hub or warehouse to its final destination. In most cases, the final destination is a delivery to an end customer. Last mile delivery aims to deliver items to a customer as quickly as possible while minimizing shipping costs to the customer and the company. The same technology that enables customers to purchase products with the click of a button comes with the expectation that that product will be quickly delivered. Fast, efficient, and reliable order fulfillment is increasingly the key to maintaining customer satisfaction and is often the last impression that a customer may have of a business transaction.

With the rise of the gig economy, companies are increasingly able to outsource or crowdsource deliveries by connecting with non-professional delivery drivers to finish a last mile delivery. As last mile deliveries are being handled by non-professional delivery drivers, these delivery drivers often make deliveries with a personal vehicle. However, this may place unwanted wear and tear on the vehicle. Things such as brakes, tires, oil, and gas need to be replaced more often than if the car is used only for personal use. In addition, the driver may not have the proper vehicle to make the delivery. For example, the driver may own a sedan or compact car, while the delivery may require a truck or box truck to properly make the delivery. In addition, to rent a proper vehicle for the delivery, the driver may have to travel to a rental vehicle location to pick up the proper delivery vehicle, and then return and pay for the vehicle later after making the delivery, which may consume additional time.

Accordingly, there is a need for a way to perform a task, such as making a delivery using a rental vehicle, while making it easy to return and pay for the rental vehicle after the task is finished.

### SUMMARY

In concordance with the instant disclosure, systems and methods that allow a person to perform a task, such as making a delivery using a rental vehicle, and that enable the person to return and pay for the rental vehicle after the task is finished, are surprisingly discovered.

Various embodiments of the present invention relate to methods of deducting a vehicle cost from a delivery income. In certain embodiments, a method may include verifying an arrival of a driver at a vehicle pickup location. A vehicle may then be assigned to the driver. The vehicle may be chosen by the driver before arrival at the pickup location. Then, the driver may complete a delivery route using the rental vehicle. The delivery route may be assigned to the driver at the pickup location. After the driver completes one or more deliveries, the driver may return to the vehicle pickup location where the driver may be re-verified. After the driver returns the vehicle, a payment may be calculated for the driver based on the delivery route. Then, the vehicle rental amount may be deducted from the payment and the resulting amount may be transferred to the driver and/or a payment account associated with the driver. The deliveries may include package deliveries, grocery deliveries, restaurant deliveries, and ride share trips.

Certain embodiments of the present invention relate to systems for deducting a vehicle rental fee from a courier payment after delivering a package by a courier from an origination location to a delivery address. A system may include one or more hardware processors configured by machine-readable instructions to verify a driver at a vehicle pickup location. Then, the driver may be assigned a vehicle. The driver may complete a delivery route using the rental vehicle. The delivery route may be assigned to the driver at the pickup location. After completion of delivery, the driver may return the vehicle to the pickup location and the system may re-verify the driver at the vehicle pickup location. A payment may then be calculated for the driver based on the delivery route. The vehicle rental amount may be deducted from the payment and the resulting amount may be transferred to the driver. For example, the payment may be transferred to a payment account associated with the driver. The deliveries may include package deliveries, grocery deliveries, restaurant deliveries, and ride share trips.

In certain embodiments, a method of deducting a vehicle rental fee from a courier payment after delivering a package by a courier from an origination location to a delivery address may include providing a delivery system having an origination system in communication with a courier device. The origination system may receive a notification that the courier has arrived at the origination location. After the courier has arrived at the origination location, the origination system may assign a vehicle to the courier. Embodiments may also include receiving, by The courier may then receive the vehicle and a package for delivery at the origination location. The courier may transport the package to the delivery address.

In certain embodiments, the delivery system may confirm a return of the courier at the origination location after delivery of the package at the delivery address. The origination system may calculate a payment for the courier and deduct a vehicle rental fee from the courier payment for the courier to obtain an adjusted payment. The origination system may then transfer the adjusted payment to the courier. The courier may receive a notification of the adjusted payment at the courier device.

In certain embodiments, the type of vehicle that is assigned to the courier may be based on the received package for delivery. The origination system may assign a delivery route at the origination location. The delivery route may be provided to the vehicle. Alternatively, the delivery route may be provided to the courier device. In certain embodiments, the origination system may receive an alert based on a deviation of the vehicle from the delivery route. The courier may receive multiple packages for delivery.

The courier may select a vehicle prior to arriving at the origination location. In certain embodiments, the vehicle rental fee may be based on a class of the vehicle. For example, a box truck may include a first rental fee, while a passenger vehicle may include a second rental fee, different from the first rental fee. In certain embodiments, the vehicle may be selected from a group consisting of a pickup truck, a box truck, a van, and a passenger vehicle.

The package for delivery may be selected from a group consisting of a consumer goods delivery, a grocery delivery, a restaurant delivery, a ride-share trip, and combinations thereof. In particular, the package for delivery may include any appropriately desired package and/or delivery item. In certain embodiments, the courier may be pre-approved by the origination system prior to the courier arriving at the origination location. The package for delivery may include a last-mile delivery, such as described above. The courier may receive a notification that a package may be available at the origination location. A notification that the courier has arrived at the origination location may be sent by the courier device upon the courier arriving at the origination location.

A system for deducting a vehicle rental fee from a courier payment after delivering a package by a courier from an origination location to a delivery address may include an arrival confirmation module configured to confirm an arrival of the courier at the origination location and an assignment module. The assignment module may be configured to assign a vehicle to the courier. A delivery route module may be configured to provide a delivery route for the courier based on a delivery address of the package. In certain embodiments, a departure confirmation module may be configured to confirm a departure of the courier and the package from the origination location. Upon confirmation of a departure from the origination location, the courier may be permitted to transport a package to a delivery address using the assigned vehicle.

A return confirmation module may be configured to confirm a return of the courier at the origination location after delivery of the package at the delivery address. A courier payment module may be configured to calculate a courier payment based on delivery of the package. A vehicle fee payment module may be configured to deduct the vehicle rental fee from the courier payment to obtain an adjusted payment. The adjusted payment may be configured to transfer the adjusted payment to a courier device.

In certain embodiments, the courier device may be selected from a group including a smartphone, a tablet, a watch, a portable computing device, a transceiver, and combinations thereof. The package for delivery may be selected from a group consisting of a consumer goods delivery, a grocery delivery, a restaurant delivery, a ride-share trip, and combinations thereof. The vehicle may be selected from a group consisting of a pickup truck, a box truck, a van, and a passenger vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a flowchart illustrating a method of deducting a vehicle rental fee, according to an embodiment of the present disclosure.

FIG. 1B is a flowchart extending from FIG. 1A and further illustrating the method of deducting a vehicle rental fee, according to an embodiment of the present disclosure.

FIG. 2 is a block diagram illustrating a system according to an embodiment of the present disclosure.

FIG. 3 is a schematic depiction of a system for deducting an amount of a vehicle rental from a delivery income of a delivery driver, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to delivery systems and methods and, in particular, systems and methods for deducting an amount of a vehicle rental from a delivery income of a delivery driver. The present technology provides a delivery driver flexibility to complete one or more deliveries without putting miles and wear and tear on a personal vehicle. The driver may arrive at a pickup location for picking up one or more packages for delivery.

A method of deducting a vehicle cost from a delivery income may include, at a vehicle pickup location, verifying an arrival of a driver. A vehicle may then be assigned to the driver. The vehicle may be chosen by the driver before arrival at the pickup location. Then, the driver may complete a delivery route using the rental vehicle. The delivery route may be assigned to the driver at the pickup location. After the driver completes the deliveries, the driver may return to the vehicle pickup location where the driver is re-verified. After the driver returns the vehicle, a payment may be calculated for the driver based on the delivery route. Then, the vehicle rental amount may be deducted from the payment and the resulting amount may be transferred to the driver.

At the pickup location, the driver may rent a vehicle. In certain embodiments, the driver may choose a vehicle and be “scanned in.” For example, depending on the driver's assigned deliveries, the driver may choose between or assigned a pickup truck, a box truck, a van, or similar vehicle for making deliveries. In certain embodiments, the vehicle may be chosen by the driver prior to arriving at the pickup location.

After choosing, or otherwise being assigned a vehicle, the driver may make deliveries using the vehicle. After the driver has completed the deliveries, the driver may return to the pickup location. In certain embodiments, upon returning to the pickup location, the driver may be “scanned-out” to confirm that the packages have been delivered. The driver may then take payment for the deliveries. The amount of the vehicle rental may be deducted from the driver's payment. The scanning may be completed using a smart device. In certain embodiments, an application loaded on the smart device may enable the driver to reserve a vehicle, route deliveries, and/or take payment minus the vehicle rental fee. Delivery may include package deliveries, grocery deliveries, restaurant deliveries, and ride share trips. In particular, the vehicle rental may be deducted from the driver's payment for any appropriately desired service rendered while using the vehicle.

Advantageously, the present technology enables a delivery driver to rent a vehicle for completing deliveries. The vehicle may be rented at the same location where the delivery route is assigned. After the driver drops off the one or more packages at a correct delivery location, the driver may return to the pickup location to confirm that the deliveries have been made. The driver may then receive payment for making the deliveries minus the cost of renting the vehicle. The present technology may allow a delivery driver to make deliveries without using the driver's personal car and then easily receive payment for those deliveries. As such, the present technology has many advantages.

Example embodiments of the present technology are provided with reference to the several figures enclosed herewith.

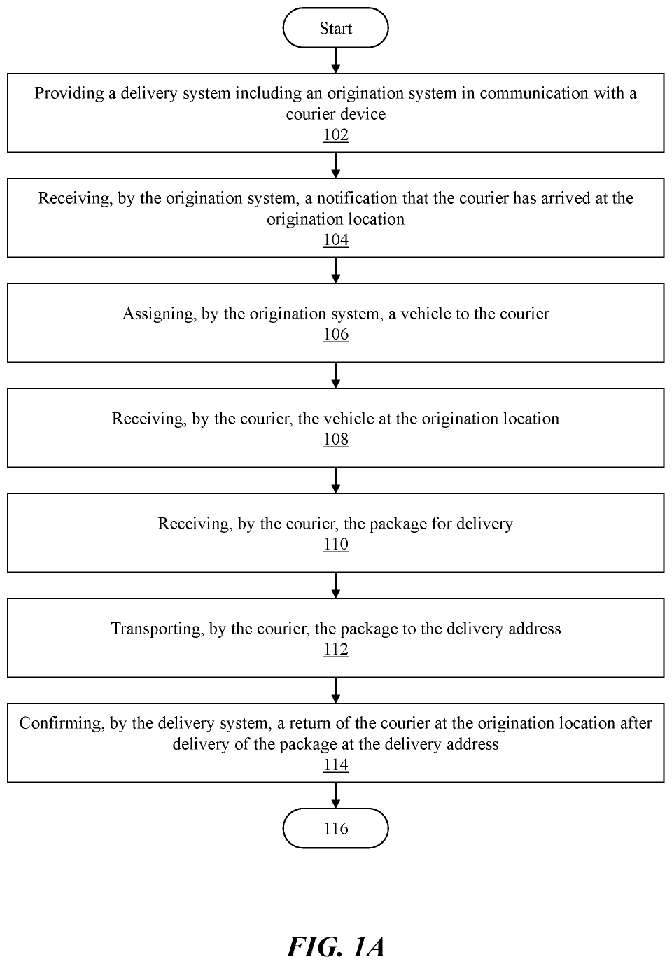

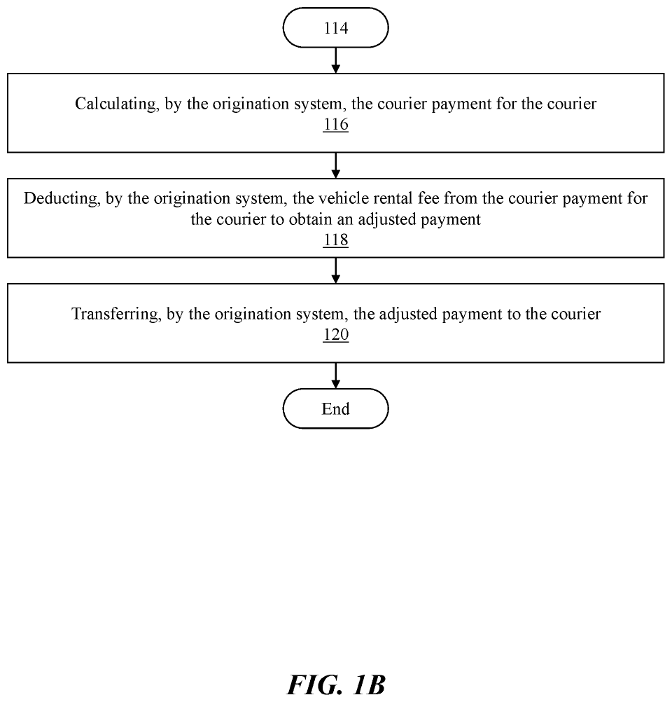

FIGS. 1A to 1B are flowcharts that describe a method of deducting a vehicle rental fee, according to some embodiments of the present disclosure. At step 102, the method may include providing a delivery system including an origination system in communication with a courier device. At step 104, the method may include receiving, by the origination system, a notification that the courier has arrived at the origination location. At step 106, the method may include assigning, by the origination system, a vehicle to the courier. At 108, the method may include receiving, by the courier, the vehicle at the origination location. In certain embodiments, at step 110, the method may include receiving, by the courier, the package for delivery. At step 112, the method may include transporting, by the courier, the package to the delivery address. At step 114, the method may include confirming, by the delivery system, a return of the courier at the origination location after delivery of the package at the delivery address. At step 116, the method may include calculating, by the origination system, the courier payment for the courier. Then, at step 118, the method may include deducting, by the origination system, the vehicle rental fee from the courier payment for the courier to obtain an adjusted payment. Then at step 120, the method may include transferring, by the origination system, the adjusted payment to the courier. The origination system may deduct the vehicle rental fee from the courier payment for the courier to obtain an adjusted payment.

In certain embodiments, the origination system may transfer the adjusted payment to the courier. This may include receiving a notification of the adjusted payment at the courier device. This may also include transferring a payment to an account associated with the courier. The origination system may assign the vehicle to the courier based on the received package for delivery. A delivery route may be assigned by the origination system at the origination location. The delivery route may be provided to the vehicle and/or the courier device. In certain embodiments, the origination system may receive an alert based on a deviation of the vehicle from the delivery route. The courier may receive multiple packages for delivery. In certain embodiments, the vehicle may be assigned to the courier prior to courier having arrived at the origination location and the vehicle rental fee may be based on a class of the vehicle. The vehicle may be selected from a group consisting of a pickup truck, a box truck, a van, and a passenger vehicle.

In certain embodiments, the package for delivery may be selected from a group consisting of a consumer goods delivery, a grocery delivery, a restaurant delivery, a ride-share trip, and combinations thereof. The courier may be pre-approved by the origination system prior to the courier having arrived at the origination location. The package for delivery may comprise a last-mile delivery. In certain embodiments, the method may include receiving, by the courier, a notification that the package may be available at the origination location. A notification that the courier has arrived at the origination location may be sent by the courier device upon the courier arriving at the origination location.

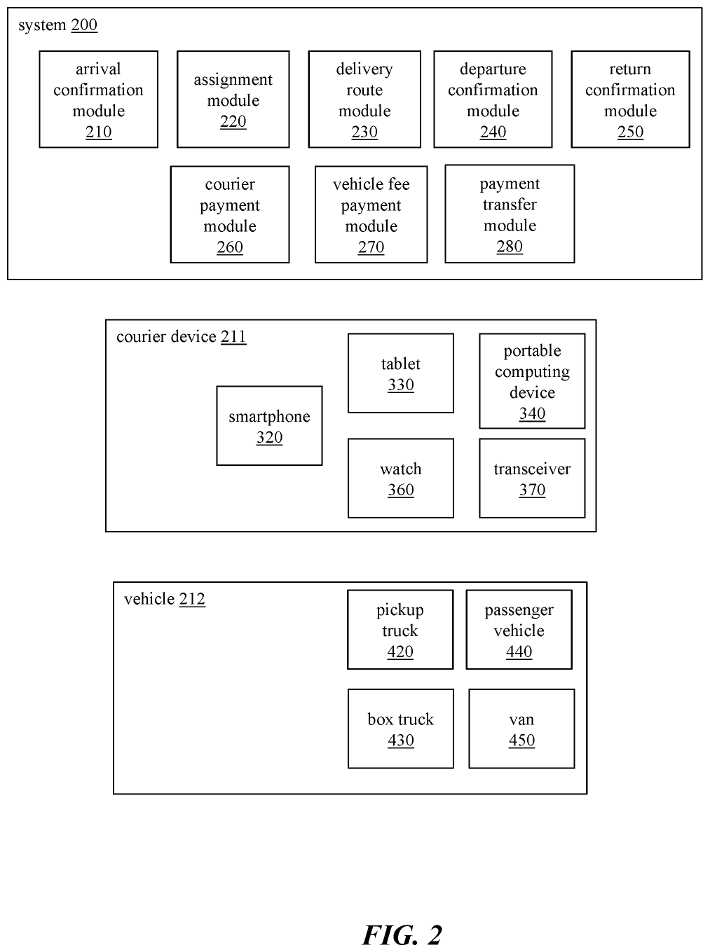

FIG. 2 is a block diagram that describes a system 200, according to some embodiments of the present disclosure. The system 200 may include an arrival confirmation module 210, an assignment module 220, a delivery route module 230, a departure confirmation module 240, a return confirmation module 250. A courier payment module 260, a vehicle fee payment module 270, and a payment transfer module 280.

The arrival confirmation module 210 may be configured to confirm an arrival of the courier at the origination location. The assignment module 220 may be configured to assign a vehicle to the courier. The delivery route module 230 may be configured to provide a delivery route for the courier based on a delivery address of the package. The departure confirmation module 240 may be configured to confirm a departure of the courier and the package from the origination location. The return confirmation module 250 may be configured to confirm a return of the courier at the origination location after delivery of the package at the delivery address. The courier payment module 260 may be configured to calculate a courier payment based on delivery of the package. The vehicle fee payment module 270 may be configured to deduct the vehicle rental fee from the courier payment to obtain an adjusted payment, and a payment transfer module 280 may be configured to transfer the adjusted payment to a courier device 211. For example, the payment transfer module may be configured to transfer the adjusted payment to an account associated with the courier and/or the courier device 211. In certain embodiments, the courier device 211 may be selected from a group consisting of a smartphone 320, a tablet 330, a portable computing device 340, a watch 360, and a transceiver 370. The vehicle 212 may include a pickup truck 420, a box truck 430, a passenger vehicle 440, and a van 450. However, as would be apparent to someone of ordinary skill in the art, the vehicle 212 may include any appropriately desired vehicle 212 including a motorcycle and other vehicles 212 for making the delivery, depending on considerations such as size, weight, temperature, packaging, and the like.

In certain embodiments, the system 200 may be configured for enabling the driver to be scanned and verified using the courier device 211. In addition, an application loaded onto the courier device 211 may enable the driver to reserve the vehicle, route deliveries, and take payment. In some cases, the system 200 may include a computing platform 202. In particular, the system may be implemented using a computing platform 202 including a computing device such as a smart device, a smart phone, a tablet, a tablet computer, and other appropriately desired computing platforms. The computing platform 202 may be communicably coupled with a remote platform 204. In some cases, users may access the system 200 via the remote platform 204. The computing platform 202 may be configured by machine-readable instructions 206. Machine-readable instructions 206 may be implemented within a processor 222, such as an administrative portal including modules. The modules may be implemented as one or more of functional logic, hardware logic, electronic circuitry, software modules, and the like.

In certain embodiments, the computing platform 202, may be communicatively coupled to the remote platform 204. The communicative coupling may include communicative coupling through a networked environment 218. The networked environment 218 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which a computing platform 202 and a remote platform 204 may be operatively linked via some other communication coupling. The computing platform 202 may be configured to communicate with the networked environment 218 via wireless or wired connections. In addition, in certain embodiments, the computing platform 202 may be configured to communicate directly with another computing platform 202 via wireless or wired connections. Examples of the computing platform 202 may include, but is not limited to, smartphones, wearable devices, tablets, laptop computers, desktop computers, Internet of Things (IoT) device, or other mobile or stationary devices. In an embodiment, system 200 may also include one or more hosts or servers, such as the remote platform 204 connected to the networked environment 218 through wireless or wired connections. According to one embodiment, the remote platform 204 may be implemented in or function as base stations (which may also be referred to as Node Bs or evolved Node Bs (eNBs)). In other embodiments, the remote platform 204 may include a web server, a mail server, and other application servers, etc. According to certain embodiments, the remote platform 204 may be a standalone server, networked server, or an array of servers.

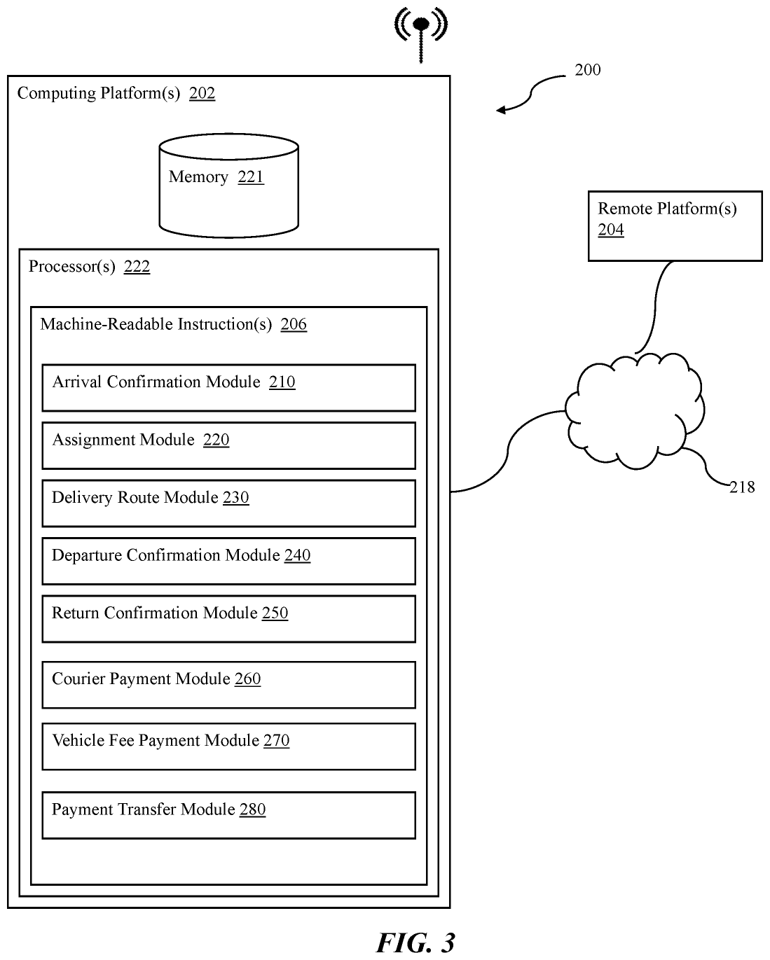

The computing platform 202 may include a processor 222 for processing information and executing instructions or operations. The processor 222 may be any type of general or specific purpose processor. In some cases, multiple processors may be utilized. In fact, the processor 222 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In certain embodiments, the processor 222 may be remote from the computing platform 202, such as disposed within a remote platform like the remote platform 204 of FIG. 3.

The processor 222 may perform functions associated with the operation of system 200 which may include, for example, precoding of antenna gain/phase parameters, encoding and decoding of individual bits forming a communication message, formatting of information, and overall control of the computing platform 202, including processes related to management of communication resources.

The computing platform 202 may further include or be coupled to a memory 221 (internal or external), which may be coupled to the processor 222, for storing information and instructions that may be executed by the processor 222. The memory 221 may be one or more memories and of any type suitable to the local application environment and may be implemented using any suitable volatile or nonvolatile data storage technology such as a semiconductor-based memory device, a magnetic memory device and system, an optical memory device and system, fixed memory, and removable memory. For example, memory 221 may consist of any combination of random access memory (RAM), read only memory (ROM), static storage such as a magnetic or optical disk, hard disk drive (HDD), or any other type of non-transitory machine or computer readable media. The instructions stored in memory 221 may include program instructions or computer program code that, when executed by the processor 222, enable the computing platform 202 to perform tasks as described herein.

In some embodiments, the computing platform 202 may also include or be coupled to one or more antennas for transmitting and receiving signals and/or data to and from the computing platform 202. An antenna may be configured to communicate via, for example, a plurality of radio interfaces that may be coupled to the antenna. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of deducting a vehicle rental fee from a courier payment after delivering a package by a courier from an origination location to a delivery address, the method comprising:
providing a delivery system including an origination system in communication with a courier device;
receiving, by the origination system, a notification that the courier has arrived at the origination location;
assigning, by the origination system, a vehicle to the courier;
receiving, by the courier, the vehicle at the origination location;
receiving, by the courier, the package for delivery;
transporting, by the courier, the package to the delivery address;
confirming, by the delivery system, a return of the courier at the origination location after delivery of the package at the delivery address;
calculating, by the origination system, the courier payment for the courier;
deducting, by the origination system, the vehicle rental fee from the courier payment for the courier to obtain an adjusted payment; and
transferring, by the origination system, the adjusted payment to the courier.

2. The method of claim 1, wherein transferring, by the origination system, the adjusted payment to the courier includes receiving a notification of the adjusted payment at the courier device.

3. The method of claim 1, wherein assigning, by the origination system, the vehicle to the courier is based on the received package for delivery.

4. The method of claim 1, further comprising assigning, by the origination system, a delivery route at the origination location.

5. The method of claim 4, wherein the delivery route is provided to the vehicle.

6. The method of claim 4, wherein the delivery route is provided to the courier device.

7. The method of claim 4, wherein the origination system receives an alert based on a deviation of the vehicle from the delivery route.

8. The method of claim 1, wherein receiving, by the courier, the package for delivery includes receiving multiple packages for delivery.

9. The method of claim 1, wherein assigning, by the origination system, the vehicle to the courier includes assigning the vehicle based on a vehicle selection by the courier prior to courier having arrived at the origination location.

10. The method of claim 1, wherein the vehicle rental fee is based on a class of the vehicle.

11. The method of claim 1, wherein the vehicle is selected from a group consisting of a pickup truck, a box truck, a van, and a passenger vehicle.

12. The method of claim 1, wherein the package for delivery is selected from a group consisting of a consumer goods delivery, a grocery delivery, a restaurant delivery, a ride-share trip, and combinations thereof.

13. The method of claim 1, wherein the courier is pre-approved by the origination system prior to the courier having arrived at the origination location.

14. The method of claim 1, wherein the package for delivery comprises a last-mile delivery.

15. The method of claim 1, further comprising receiving, by the courier, a notification that the package is available at the origination location.

16. The method of claim 1, wherein the notification that the courier has arrived at the origination location is sent by the courier device upon the courier arriving at the origination location.

17. A system for deducting a vehicle rental fee from a courier payment after delivering a package by a courier from an origination location to a delivery address, the system comprising:
an arrival confirmation module configured to confirm an arrival of the courier at the origination location;
an assignment module configured to assign a vehicle to the courier;
a delivery route module configured to provide a delivery route for the courier based on a delivery address of the package;
a departure confirmation module configured to confirm a departure of the courier and the package from the origination location, wherein upon confirmation of departure from the origination location, the courier is permitted to transport a package to a delivery address using the assigned vehicle;
a return confirmation module configured to confirm a return of the courier at the origination location after delivery of the package at the delivery address;
a courier payment module configured to calculate a courier payment based on delivery of the package;
a vehicle fee payment module configured to deduct the vehicle rental fee from the courier payment to obtain an adjusted payment; and
a payment transfer module configured to transfer the adjusted payment to a courier device.

18. The system of claim 17, wherein the courier device is selected from a group including: a smartphone, a tablet, a watch, a portable computing device, a transceiver, and combinations thereof.

19. The system of claim 17, wherein the package for delivery is selected from a group consisting of a consumer goods delivery, a grocery delivery, a restaurant delivery, a ride-share trip, and combinations thereof.

20. The system of claim 17, wherein the vehicle is selected from a group consisting of a pickup truck, a box truck, a van, and a passenger vehicle.
